(19) United States
(12) Patent Application Publication
(10) Pub. No.: US 2010/0231629 A1
(43) Pub. Date: Sep. 16, 2010

(54) PRINTER CONTROL APPARATUS

(75) Inventor: Akihiko Kobayashi, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/723,323

(22) Filed: Mar. 12, 2010

(30) Foreign Application Priority Data
Mar. 13, 2009 (JP) 2009-060755

(51) Int. Cl. B41J 29/38

(52) U.S. Cl. 347/14

(57) ABSTRACT

A printer control apparatus including a print medium selection unit that presents a list of a plurality of print media and receives any one selected from the print media; a print quality selection unit that presents a list of a plurality of print qualities and receives any one selected from the plurality of print qualities; a print start unit that starts the print in a state a cartridge filled with the ink suitable to a selected print medium is connected to the common nozzle when a high print quality of the print qualities is selected, and starts the print regardless of which one of the plurality of cartridges is connected to the common nozzle when a low print quality of the print qualities is selected; and a guide unit that assigns to raster data to be printed guide raster data.

### CROSS REFERENCES TO RELATED APPLICATIONS

The entire disclosure of Japanese Patent Application No. 2009-060755, filed Mar. 13, 2009 expressly incorporated by reference herein.

### BACKGROUND

1. Technical Field

The present invention relates to a technology for controlling an ink jet printer, more particularly to an ink cartridge switching.

2. Related Art

In the related art, there is known an ink jet printer in which a plurality of ink cartridges is mounted for one color, each cartridge being filled with ink whose composition is optimized according to the kind of print medium, the cartridge being automatically or semi-automatically switched according to the kind of print medium. When an ink cartridge is exchanged in the ink jet printer, the ink is consumed since the ink flow path is washed (for example, referring to JP-A-2001-58416).

Another example of the above-described related art is disclosed in JP-A-2007-174069.

However, in the ink jet printer of the related art in which the ink cartridge is automatically or semi-automatically switched according to the kind of print medium, in order to guarantee a proper print result, it is forbidden to make a print by combining a print medium set by a user and an ink which is an unsuitable ink. For this, even in a so-called draft print used to confirm a rough completion of printed materials, when the ink used for the just previous print is not suitable to the print medium, there are concerns that ink is wasted due to the exchange of the ink cartridge and printing cannot be started until the exchange process is completed.

### SUMMARY

An advantage of some aspects of the invention is to suppress the waste of ink and the delay in the start of print that occur when an ink cartridge is switched.

A printer control program to achieve the above object is a printer control program to control an ink jet printer having a switching unit that is attached to a plurality of cartridges filled with ink of different compositions and connects any one of the plurality of cartridges to a common nozzle, the printer control program enabling a computer to function as a print medium selection unit that presents a list of a plurality of print media and receives any one selected from the print media; a print quality selection unit that presents a list of a plurality of print qualities and receives any one selected from the plurality of print qualities; and a print start unit that starts printing in a state where a cartridge filled with ink suitable to the selected print medium is connected to the common nozzle when a relatively high print quality of the print qualities is selected, and starts the print regardless of which one of the plurality of cartridges is connected to the common nozzle when a relatively low print quality of the print qualities is selected.

According to an aspect of the invention, it is guaranteed to have a proper print result in which an ink suitable to the selected print medium is used when a relatively high print quality of the print qualities is selected, and the waste of ink and the delay in the start of printing occurring when an ink cartridge is switched do not occur when a relatively low quality of the print qualities is selected.

In a printer control program to achieve the above object, when the cartridge filled with an ink that is not suitable to the selected print medium is connected to the common nozzle, it is also desirable to enable a computer to function as a guide unit that assigns to raster data to be printed guide raster data indicating that printing was performed using an ink that is not suitable to the selected print medium.

According to another aspect of the invention, when a proper print result was not obtained since an ink that is not suitable to the print medium was used, it is possible to make the user recognize that a more desirable print result can be obtained by switching the ink.

In a printer control program to achieve the above object, it is also desirable that the print start unit set a color conversion table suitable to the ink filled in the cartridge that is connected to the common nozzle.

According to another aspect of the invention, since a color conversion table suitable to the ink used for printing (current ink) is set regardless of whether the ink used for printing is suitable to a print medium or not, a high quality print result is obtained compared with a case that a color conversion table is fixed according to the print medium regardless of the ink used for printing.

Further, the invention is embodied as a recording medium of a printer control program, a printer control method and a printer control apparatus. Of course, the recording medium of a computer control program may be a magnetic recording medium, a magneto-optical recording medium, or a certain recording medium to be developed in the future.

### BRIEF DESCRIPTION OF THE DRAWINGS

The invention will be described with reference to the accompanying drawings, wherein like numbers reference like elements.

FIG. 1 is a block diagram in accordance with an embodiment of the invention.

FIG. 2 is a block diagram in accordance with an embodiment of the invention.

FIG. 3 is a flow chart in accordance with an embodiment of the invention.

FIG. 4 is a view showing GUI in accordance with an embodiment of the invention.

FIG. 5 is a table showing a combination of a print medium, a suitable ink and a color conversion table in accordance with an embodiment of the invention.

FIG. 6 is a table showing a definition of print quality in accordance with an embodiment of the invention.

### DESCRIPTION OF EXEMPLARY EMBODIMENTS

Hereinafter, an embodiment of the invention will be described with reference to accompanying drawings. Further, like symbols reference like elements in each drawing and the explanation thereof will be omitted.

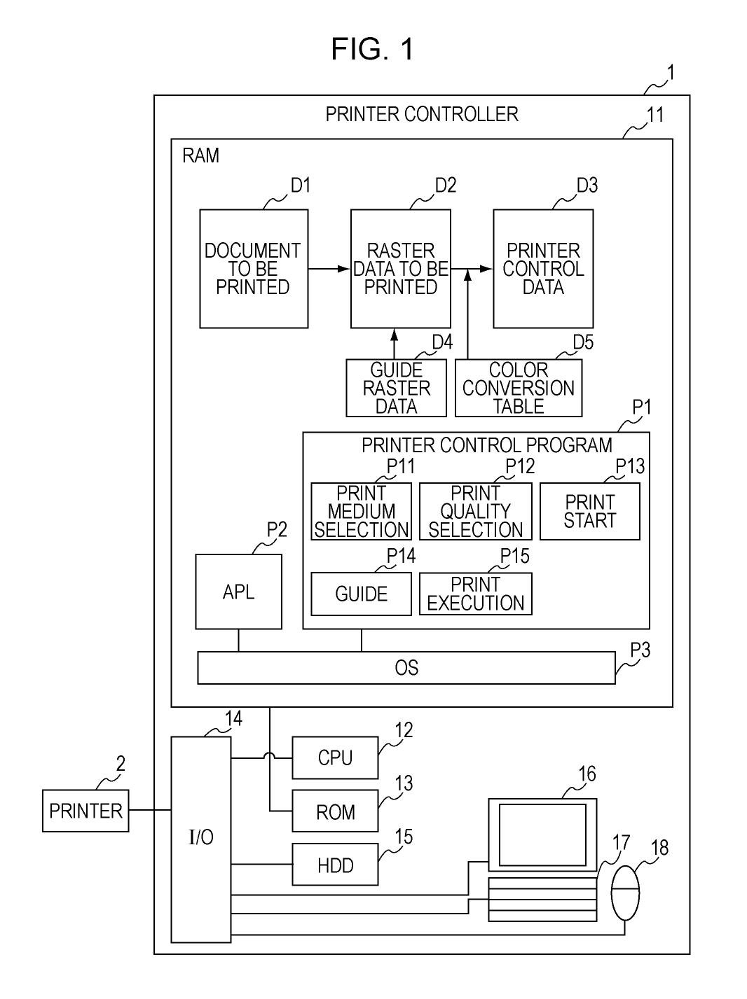

FIG. 1 is a block diagram showing an embodiment of a printer control apparatus and a printer control program in accordance with the invention. The printer control apparatus 1 includes a PC (personal computer) having a RAM 11, a CPU 12, a ROM 13, an input/output unit 14 and a hard disc drive (HDD) 15, and input/output devices such as a mouse 18, a key board 17 and a display 16 that are connected to the input/output unit 14, respectively. A printer 2 is connected to the input/output unit 14. The hard disc drive 15 stores various kinds of computer programs such as a printer control program P1, an operating system (OS) P3 and an application program (APL) P2 that are loaded in the RAM 11 and executed by the CPU 12. A document D1 to be printed that is processed by the printer control program P1 is edited by the application program P2 such as a word processor program or the like.

The printer control program P1 is a computer program that edits raster data D2 to be printed from the document D1 to be printed, converts the raster data D2 to be printed into print control data D3 and transmits the print control data D3 to the printer 2. The printer control program P1 is configured of a plurality of modules including a print medium selection module P11, a print quality selection module P12, a print start module P13, a guide module P14 and a print execution module P15.

The print medium selection module P11 realizes a function of displaying a list of a plurality of print media on the display 16 and receiving any one selected from the print media. The print quality selection module P12 realizes a function of displaying a list of a plurality of print qualities on the display 16 and receiving any one selected from the print qualities. The print start module P13 realizes a function of setting a print condition including a print medium and a print quality and starting the print. The guide module P14 realizes a function of assigning to raster data to be printed guide raster data indicating that printing was performed by the ink that is not suitable to a selected print medium, in cooperation with the operating system P3. The print execution module P15 realizes a function of converting the raster data D2 to be printed into the print control data D3 using a color conversion table D5. The color conversion table D5 is a lookup table that correspondingly matches the brightness of R (Red), G (Green) and B (Blue) and the concentration of each ink. The print execution module P15 manages a plurality of color conversion tables D5 by correspondingly matching them to print media and ink. The CPU 12 functions as a print medium selection unit, a print quality selection unit, a print start unit, a print unit and a guide unit by executing these program modules configuring the printer control program P1.

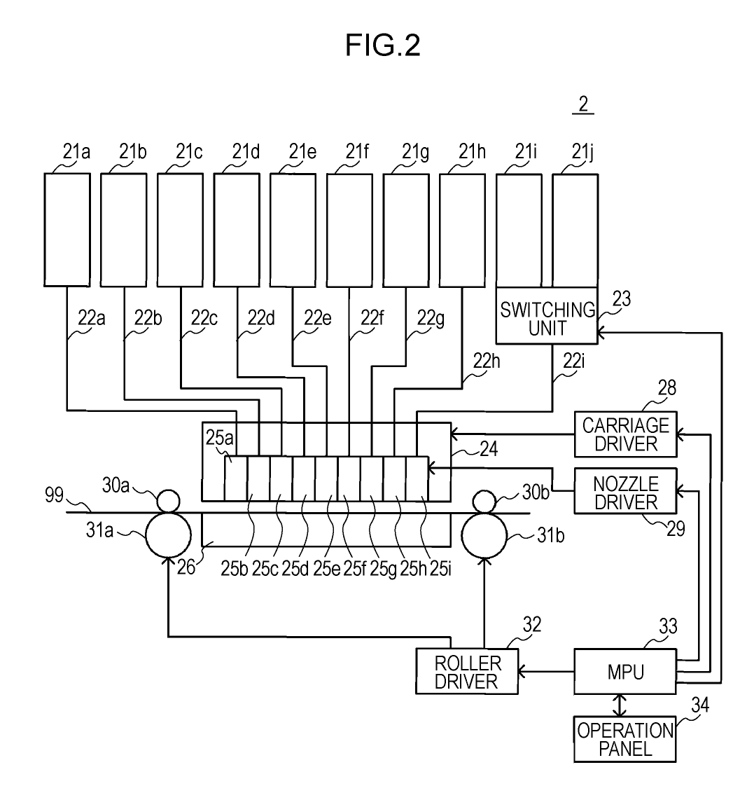

FIG. 2 is a block diagram showing a printer 2 controlled by a printer control apparatus 1. The printer 2 is an ink jet printer that forms an image by spraying ink provided by a plurality of cartridges 21a to 21j on a print medium 99. The cartridges 21a to 21j are filled with ink of different compositions. The printer 2 includes independent flow paths 22a to 22h whose inlets are attached to the cartridges 21a to 21h, respectively, a switching unit 23 whose two inlets of an inner flow path are attached to the cartridges 21i and 21j, a common flow path 22i that is connected to one outlet of the inner flow path of the switching unit 23, a nozzle group 25a to 25h connected to the independent flow paths 22a to 22h, respectively, and a common nozzle group 25i connected to the common flow path 22i.

The independent flow paths 22a to 22h and the common flow path 22i are formed of a flexible pipe or the like. The ink filled in the cartridges 21a to 21h flows through the independent flow paths 22a to 22h whose inlets are connected to the cartridges 21a to 21h, respectively. The switching unit 23 has an inner flow path having two inlets and one outlet. The inner flow path of the switching unit 23 has one inlet connected to the cartridge 21i and the other connected to the cartridge 21j. The switching unit 23 has a switching valve that connects any one of two inlets of the inner flow path and the outlet of the inner flow path, an actuator to drive the switching valve and a driving circuit to drive the actuator. Two kinds of ink filled in the cartridge 21i and the cartridge 21j flow through the common flow path 22i connected to the outlet of the inner flow path of the switching unit 23. Here, the ink filled in the cartridge 21i is referred to the photo black ink, and the ink filled in the cartridge 21j is referred to matte black ink. The independent nozzle groups 25a to 25h and the common nozzle group 25i each include a plurality of nozzles to discharge ink in the piezo method or in the thermal method. The independent nozzle groups 25a to 25h each discharge one kind of ink. The common nozzle group 25i discharges the photo black ink and matte black ink filled in the cartridge 21i and cartridge 21j, respectively. Further, while the independent nozzle groups 25a to 25h and the common nozzle group 25i are serially arranged in the transport direction of the print medium 99 in FIG. 2 (horizontal direction of FIG. 2) for the sake of convenience, they are serially arranged in the vertical direction to the transport direction of the print medium 99 (the vertical direction to the paper in FIG. 2) in a practical case. Accordingly, it is possible to form a color image of a fixed width on the print medium 99 by moving the carriage 24 from one end to the other in forward and backward region in one direction. The independent nozzle groups 25a to 25h and the common nozzle group 25i are driven by a nozzle driver 29. The nozzle driver 29 includes an electronic circuit to convert a control signal output from the MPU 33 into a driving signal to drive the independent nozzle groups 25a to 25h and the common nozzle group 25i.

The nozzle groups 25a to 25i that are totally divided into nine are mounted on the carriage 24. The carriage 24 is supported to move forward and backward in the vertical direction to the transport direction of the print medium 99 (the vertical direction to the paper in FIG. 2). The carriage 24 is driven by the carriage driver 28. The carriage driver 28 includes a stepping motor, a driving force transfer unit (gear, belt and so on) and a driving circuit. There is a platen 26 mounted just under the forward and backward range of the carriage 24. A gap is set between the carriage 24 and the platen 26, the gap corresponding to the thickness of the print medium 99.

The print medium 99 is transported in the gap between the carriage 24 and the platen 26 by driving rollers 31a and 31b and driven roller 32a and 32b. The driving rollers 31a and 31b are driven by a roller driver 32. The roller driver 32 includes a stepping motor, a driving force transfer unit (gear, clutch and so on) and a driving circuit.

The switching unit 23, the carriage driver 28, the nozzle driver 29 and the roller driver 32 are controlled by an MPU (Microprocessor unit) 33. The connection state of the inner path of the switching unit 23 is managed by the MPU 33 as a part of status information. The MPU 33 outputs a control signal to control the carriage driver 28, the nozzle driver 29 and the roller driver 32 on the basis of the print control data D3 received from the printer controller 1.

The printer 2 includes an operation panel 34. The operation panel 34 includes a flat panel display or an indicator and a plurality of operation keys. A switching requirement of the cartridges 21i and 21j to connect to the common nozzle group 25i is input by operating an ink switching key that is one of operation keys of the operation panel 34.

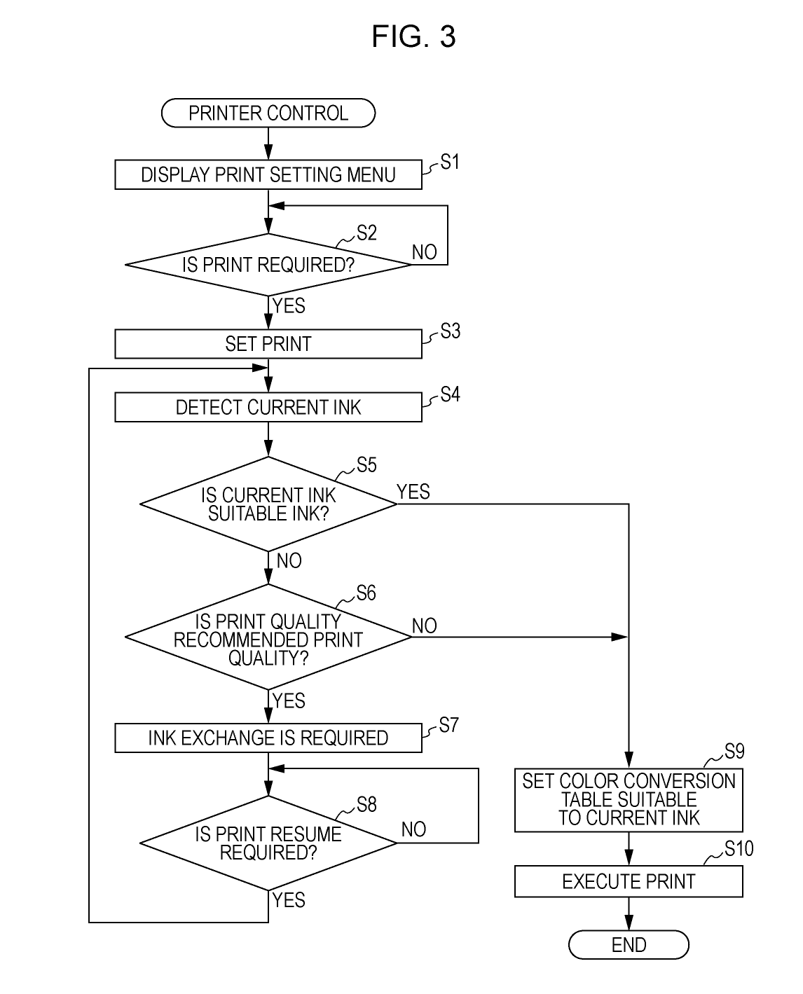

FIG. 3 is a flow chart illustrating a flow of printer control processes by a printer controller 1. In the printer control processes illustrated in FIG. 3, S1 process is controlled by a print medium selection module P11 and a print quality selection module P12, S3 to S9 processes are controlled by a print start module P13 and S10 process is controlled by a print execution module P15 and a guide module P14.

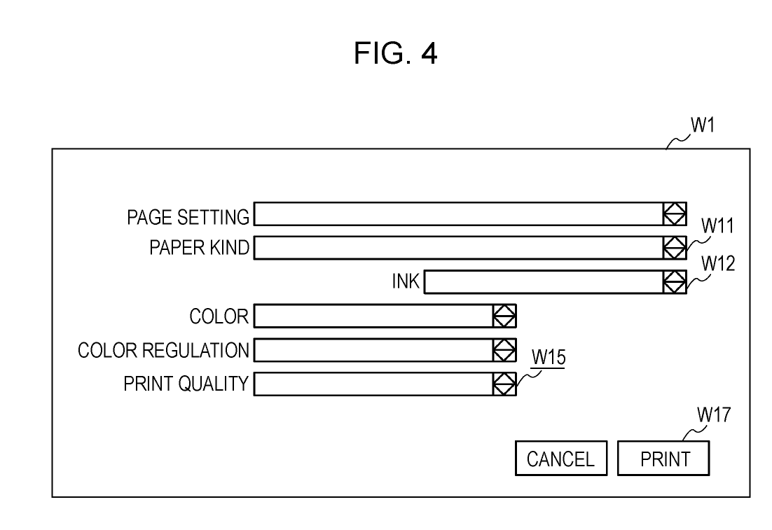

At first, a print setting menu is displayed on a display 16 in response to a requirement of an application program P2. FIG. 4 shows an example of a print setting menu displayed in the display 16. A print setting menu W1 is a dialogue window having a plurality of widgets arranged therein. Texts (paper kind, print quality and so on) to guide a function of each widget are arranged near each widget.

When a print medium selection widget W11 is selected, it makes a pop-up display of a list of text indicating a plurality of print media, displays a text indicating a selected print medium and holds an identifier of the selected print medium. When an ink selection widget W12 is selected, it makes a pop-up display of a list of texts (photo black, matte black) indicating the ink filled in the cartridge 21i and cartridge 21j, displays a text indicating the ink filled in the selected cartridge and holds an identifier of the ink filled in the selected cartridge. When a print quality selection widget W15 is selected, it makes a pop-up display of a list of texts indicating a plurality of print qualities, displays a text indicating the selected print quality and holds an identifier of the selected print quality.

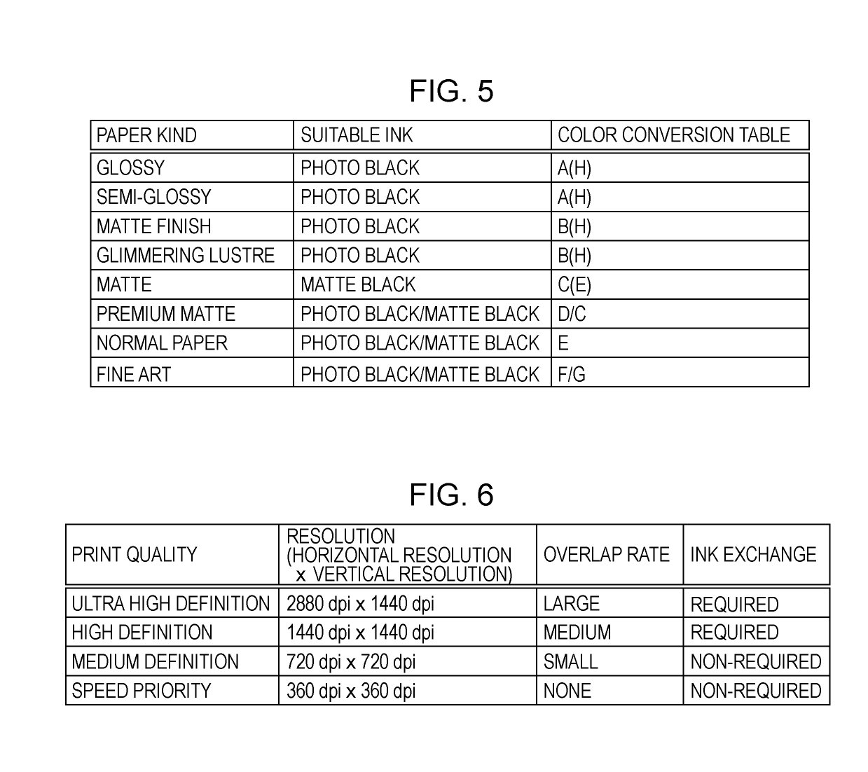

A combination of a print medium, a suitable ink and a color conversion table is determined in advance, and their combination is defined by a printer control program P1. A combination of a print medium, a suitable ink and a color conversion table according to an aspect of the embodiment is shown in FIG. 5. The photo black ink or the matte black ink or both of them is or are predetermined as suitable ink for each print medium. When a print medium suitable to only one of the photo black ink and the matte black ink is selected by the print medium selection widget W11, the ink selection widget W12 displays only one of the photo black ink and the matte black ink, which is suitable to the selected print medium, and does not receive the selection of the other.

Each of the plurality of print qualities is defined by the printer control program P1. The definition of the plurality of print qualities according to the embodiment is shown in FIG. 6. The print quality is defined by a resolution (horizontal resolution and vertical resolution), an overlap rate and whether an ink exchange is required or not. The print quality increases in the order of “speed priority”, “medium definition”, “high definition” and “ultra high definition”. The “speed priority”, “medium definition”, “high definition” and “ultra high definition” are also texts that are displayed by the print quality selection widget W15. In the “speed priority” and “medium definition” of relatively low qualities, it is determined that ink exchange is not required. In the “high definition” and “ultra high definition” of the relatively high qualities, it is determined that ink exchange is essential and they are recommended print qualities. The overlap rate is an index that has a positive correlation with the number of times of moving the carriage 24 from one end to the other in forward and backward region in order to form a color image of a predetermined width on the print medium 99. As the number of times of moving the carriage 24 from one end to the other in forward and backward region in order to form a color image of a fixed width on the print medium 99 becomes large, it is possible to form a better image. Referring to FIG. 6, the overlap rate is described as “large”, “medium”, “small” and “none” in the order from largest to smallest.

The print setting menu W1 is displayed until the print is required by a user (S2). In detail, the print setting menu W1 is continuously displayed on the display 16 until a print button W17 is selected.

When a print is required by the user, a print setting process is executed (S3). In detail, various kinds of parameters to determine print conditions are set on the basis of an identifier held by each widget that is arranged in the print setting menu W1.

Next, a current ink is detected (S4). The current ink is an ink filed in a cartridge connected to a common nozzle group 25i. In detail, it is detected which one of the cartridge 21i and the cartridge 21j is connected to the common nozzle group 25i when the printer controller 1 receives status information managed by an MPU 33 of a printer 2.

Next, it is determined whether the current ink is a suitable ink or not (S5). In detail, the ink that is defined to be a suitable ink of the print medium selected by operating the print medium selection widget W11, and the ink filled in the cartridge 21i or 21j connected to the common nozzle group 25i are compared.

When the current ink is not a suitable ink, it is determined whether the selected print quality is a recommended print quality (S6). In detail, a print quality selected by operating the print quality selection widget W15 and the recommended print qualities defined in advance (“high definition” and “ultra high definition”) are compared.

When the selected print quality is the recommended print quality, the user is required to exchange ink (S7). In detail, for example, a string requiring the ink exchange and a pop-up window having a confirmation button arranged thereon are displayed on the display 16.

The user can switch a cartridge that is connected to the common nozzle group 25i by pushing an ink switching key installed on the operation panel 34 of the printer 2. In detail, the MPU 33 outputs a control signal to the switching unit 23 on the basis of operation information output from the operation panel 34, and the switching unit 23 switches a connection state of an inner path by driving a switching valve on the basis of a control signal output from the MPU 33. Consequently, a cartridge connected to the common nozzle group 25i through the switching unit 23 and the common flow path 22i is switched from one of the cartridge 21i and the cartridge 21j to the other.

Further, since an inner path of the switching unit 23, the common flow path 22i and the common nozzle group 25i are cleaned before and after the cartridge connected to the common nozzle group 25i is switched, the photo black ink or the matte black ink filled in the cartridge 21i and the cartridge 21j, respectively, is consumed before the print is executed. Generally, it takes about 2 or 3 minutes for the cartridge connected to the common nozzle group 25i to be switched. However, even in a case that the current ink is not a suitable ink, when the print quality is not the recommended print quality (in a case of NO at step S6), since it is unnecessary to switch the cartridge connected to the common nozzle group 25i, the photo black ink and the matte black ink filled in the cartridge 21i and the cartridge 21j are not consumed before the print is executed.

The ink exchange is required until a print resume is required by the user (S8). In detail, the user is required to perform the print resume by enabling him or her to select a confirmation button of a pop-up window.

When the print resume is required by the user, steps S4 and S5 are repeatedly processed. When the current ink is a suitable ink, a color conversion table D5 suitable to the selected print medium and the current ink is set (S9). In other words, the color conversion table D5 is set according to a combination shown in FIG. 5. In detail, for example, when “Glossy paper” or “Semi-Glossy paper” is selected and the current ink is a suitable ink of the photo black ink, a color conversion table A is set. When “Matte Finish paper” or “Glimmering Lustre paper” is selected and the current ink is a suitable ink of the photo black ink, a color conversion table B is set. When a “Matte paper” or “Premium Matte paper” is selected and the current ink is a suitable ink of the matte black ink, a color conversion table C is set. When “Premium Matte paper” is selected and the current ink is a suitable ink of the photo black ink, a color conversion table D is set. When a “Normal paper” is selected, a color conversion table E is set regardless of kind of the current ink. In the color conversion table E, brightness of R (Red), G (Green) and B (Blue) and concentration of each ink are correspondingly matched in order to be widely suitable to properties of matte-class print medium. Further, when the current ink is not a suitable ink and the print quality is not a recommended print quality, a color conversion table defined as a current ink that is not a suitable ink and a color conversion table suitable to a print medium is parenthesized in FIG. 5. In detail, for example, when “Glossy paper”, “Semi-glossy paper”, “Matte Finish paper” or “Glimmering Lustre paper” is selected and the current ink is the mat black ink that is not a suitable ink, a color conversion table H is set. In the color conversion table H, brightness of R (Red), G (Green) and B (Blue) and concentration of each ink are correspondingly matched to be widely suitable to the property of glossy-class print media. When the “Matte paper” is selected and the current ink is the photo black ink that is not a suitable ink, a color conversion table E that is widely suitable to the property of the matte-class print medium is set. As such, since the color conversion table suitable to the current ink is set regardless of whether the current ink is suitable to the print medium or not, a high quality print result can be obtained, compared with the case that the color conversion table is set in response to the print medium regardless of the current ink.

When the color conversion table D5 is set, the print is started and executed (S10). A detailed description will be given as follows.

In the print execution process, at first, an application program P2 requires a printer control program P1 to rasterize strings and figures configuring the document D1 to be printed through an operating system P3.

Next, the printer control program P1 required to rasterize edits raster data D2 to be printed by rasterizing the strings and figures in cooperation with the operating system P3.

Further, when the current ink is not a suitable ink, guide raster data D4 is assigned to the raster data D2 to be printed, the guide raster data D4 indicating that a print was performed by a current ink that was not suitable to a selected print medium. In detail, for example, strings such as “not suitable ink” and “clearer print result can be obtained by switching to a suitable ink”, and a figure or the like to remind the user of the ink switching are rasterized in a margin area of the raster data D2 to be printed when the guide module P14 cooperates with the operating system P3.

When the raster data D2 to be printed is edited by doing this, a color space of the raster data D2 to be printed is converted by the color conversion table D5. Subsequently, print control data D3 is generated by executing a process such as binarization. The print control data D3 is information to control discharge of ink in each nozzle and each line. The print control data D3 is transmitted to the printer 2 in a predetermined order. In the printer 2 that received the print control data D3, the MPU 33 controls the carriage driver 28, the nozzle driver 29 and the roller driver 32 on the basis of the print control data D3 so that an image is formed on the print medium 99. Further, when the current ink is not a suitable ink, a string and a figure indicating that the print was performed by the current ink that was not suitable to the selected print medium. The print medium 99 is printed. Accordingly, it is possible to make the user recognize that a better print result can be obtained by switching ink.

According to the embodiment described above, a print is started only in the state that the cartridge filled with the ink suitable to the selected print medium is connected to the common nozzle when a relatively high quality of print qualities is selected. Further, a print is started regardless of whether any one of the plurality of cartridges is connected to the common nozzle or not when a relatively low quality of print qualities is selected. Accordingly, a proper print result obtained by using an ink suitable to the selected print medium is completely guaranteed when a relatively high quality of print qualities is selected, and the waste of ink and the delay of the start of printing occurring when the ink cartridge is switched do not occur when a relatively low quality of print qualities is selected.

### Another Embodiment

While the embodiment of the invention has been illustrated and described, it will be appreciated that various changes can be made therein without departing from the spirit and scope of the invention.

For example, it is also desirable that an input of a switching requirement of cartridges 21i and 21j made by operating the operation panel 34 of the printer 2 is not needed. In detail, it is also desirable to transmit a switching requirement from the printer controller 1 to the MPU 33 of the printer 2 by controlling the print start module P13.

Further, it is also desirable to manage the recommended print qualities in each print medium. For example, it is also desirable that the recommended print quality for the normal paper is the “medium definition” and the recommended print qualities for other print media are “high definition”.

Further, it is also possible that the color conversion table D5 is configured of a lookup table that converts brightness of RGB into the separate brightness of RGB, or a lookup table that converts concentration of ink color into the separate concentration of the same ink color.

What is claimed is:

1. A printer control apparatus to control an ink jet printer having a switching unit to which a plurality of cartridges filled with ink of different compositions is attached and that connects any one of the plurality of cartridges to a common nozzle, the printer control apparatus comprising:
a print medium selection unit that presents a list of a plurality of print media and receives any one selected from the print media;
a print quality selection unit that presents a list of a plurality of print qualities and receives any one selected from the plurality of print qualities;
a print start unit that starts the print in a state when a cartridge filled with the ink suitable to a selected print medium is connected to the common nozzle when a high print quality of the print qualities is selected, and starts the print regardless of which one of the plurality of cartridges is connected to the common nozzle when a low print quality of the print qualities is selected; and
a guide unit that assigns to raster data to be printed guide raster data indicating that printing was performed using an ink that is not suitable to the selected print medium when the cartridge filled with the ink that is not suitable to the selected print medium is connected to the common nozzle.

2. The printer control apparatus according to claim 1, wherein the print start unit sets a color conversion table suitable to the ink filled in the cartridge connected to the common nozzle.

3. A memory medium that stores a printer control program to control an ink jet printer having a switching unit to which a plurality of cartridges filled with ink of different compositions is attached and that connects any one of the plurality of cartridges to a common nozzle, the printer control program causing a computer to function as:
a print medium selection unit that presents a list of a plurality of print media and receives any one selected from the print media;
a print quality selection unit that presents a list of a plurality of print qualities and receives any one selected from the plurality of print qualities;
a print start unit that starts the print in a state when a cartridge filled with ink suitable to a selected print medium is connected to the common nozzle when a relatively high print quality of the print qualities is selected, and starts the print regardless of which one of the plurality of cartridges is connected to the common nozzle when a relatively low print quality of the print qualities is selected; and
a guide unit that assigns to raster data to be printed guide raster data indicating that printing was performed using an ink that is not suitable to the selected print medium when the cartridge filled with ink that is not suitable to the selected print medium is connected to the common nozzle.
